(19) United States
(12) Patent Application Publication
(10) Pub. No.: US 2001/0007817 A1
(43) Pub. Date: Jul. 12, 2001

(54) Information processor, information processing method, and computer-readable recording medium on which a program for making a computer perform a process based on the method is recorded

(76) Inventors: Hiroshi Odagiri, Chiba-shi (JP); Tomozumi Saruwatari, Chiba-shi (JP); Haruo Hashimoto, Chiba-shi (JP)

Correspondence Address: Adams & Wilks, 50 Broadway, 31st Floor, New York, NY, 10004, US

(21) Appl. No.: 09/732,966

(22) Filed: Dec. 8, 2000

(30) Foreign Application Priority Data
Jan. 11, 2000 (JP) 2000-006121

(51) Int. Cl. H04B 1/40

(52) U.S. Cl. 455/421; 455/74

(57) ABSTRACT

An information processor capable of recognizing whether the possessor (user) of the information processor is carrying the information processor or located in the vicinity of the information processor. The information processor performs a suitable processing operation according to the possessor's (user's) carrying or non-carrying condition. The information processor has a transmitting section to transmit a signal receivable only in the range of a predetermined distance to a wristwatch type information processor previously assigned, a receiving section to receive a signal sent from the wristwatch type information processor in response to the signal transmitted by the transmitting section, a decision section to make a determination as to whether the reply signal has been received by the receiving section, and a processing operation control section to execute a predetermined processing operation depending upon the result of the determination made by the decision circuit.

### BACKGROUND OF THE INVENTION

1. Field of the Invention

The present invention relates to an information processor, such as a portable telephone, or a portable digital assistant, having a communication function, an information processing method, and a computer-readable recording medium on which a program for making a computer perform a process based on the method is recorded.

2. Description of the Related Art

Portable information processors, such as portable telephones and mobile computers, having a communication function, have recently come into wide use. A person who operates such a portable information processor can easily carry the information processor and perform communication anywhere by using the information processor. It is presupposed that the possessor (user) of such an information processor always carries the information processor. However, the possibility of the possessor losing or mislaying the information processor and the possibility of the information processor being stolen are not negligible. Therefore, there is a possibility of the information processor not being carried by the possessor (user).

When the possessor (user) is not carrying the information processor, the information processor may be left in such a state that an unauthorized person can operate the information processor without possessor's (user's) permission to perform communication and can steal or change information stored in the information processor (e.g., a telephone number list in a portable telephone).

Also, if the information processor receives a signal from an external device when the possessor (user) is not carrying the information processor, alert means (e.g., an incoming call sound means for a portable telephone) intended to inform the possessor (user) of arrival of such a signal operates continuously to annoy people in a place where the information processor exists, or to waste power for the information processor.

Further, the person who has transmitted the signal from the external device (transmitting terminal) cannot know whether the possessor (user) of the information processor is carrying the information processor, so that the communication functions of the information processor cannot be effectively performed.

### SUMMARY OF THE INVENTION

In view of the above-described problems of the conventional art, an object of the present invention is to provide an information processor capable of making a determination as to whether the possessor (user) of the information processor is carrying the information processor (or is in the vicinity of the information processor), and capable of suitably operating according to the state of being carried or not carried by the possessor (user).

To solve the above-mentioned problem and to achieve the object described above, according to one aspect of the present invention, there is provided an information processor comprising transmitting means for transmitting a signal receivable only in the range of a predetermined distance to another information processor previously assigned, receiving means for receiving a reply signal sent from the other information processor in response to the signal transmitted by the transmitting means, decision means for making a determination as to whether the reply signal has been received by the receiving means, and processing operation control means for executing a predetermined processing operation depending upon the result of the determination made by the decision means.

According to the present invention, the predetermined processing operation is performed if the distance to the other information processor is equal to or larger than the predetermined distance.

The information processor according to the present invention may further comprise command means for issuing commands to perform operations, wherein the transmitting means transmits the signal receivable only in the range of the predetermined distance to the other information processor if a predetermined operation command is issued from the operation command means, and wherein the processing operation control means executes a processing operation corresponding to the operation command issued by the operation command means depending upon the result of the determination made by the decision means.

According to the present invention, the operation command is effective if the distance to the other information processor is smaller than the predetermined distance.

According to another aspect of the present invention, there is provided an information processor comprising first receiving means for receiving a signal transmitted from an external device, transmitting means for transmitting a signal receivable only in the range of a predetermined distance to another previously assigned information processor when a signal is received by the first receiving means, second receiving means for receiving a reply signal sent from another information processor in response to the signal transmitted by the transmitting means, decision means for making a determination as to whether the reply signal has been received by the second receiving means, and alert means for performing alerting with respect to the reception of the signal by the first receiving means depending upon the result of the determination made by the decision-means.

According to the present invention, it is possible to know that the signal transmitted from the external device has been received if the distance to the other information processor is smaller than the predetermined distance.

The above-described information processor according to the present invention may further comprise changeover means for changing the transmitting means between the mode of transmitting to the another information processor and the mode of not transmitting.

According to the present invention, even if the distance to the other information processor is equal to or larger than the predetermined distance, it is possible to inhibit the predetermined operation, to make the operation command effective, and to perform alerting when the signal transmitted from the external device is received.

According to the present invention, the other information processor may be an information processor wearable on a wrist.

Therefore, the other information processor can always be worn by the possessor (user) to enable the possessor (user) to readily know whether the distance to the information processor is equal to or larger than the predetermined distance.

According to still another aspect of the present invention, there is provided an information processing method comprising a transmitting step of transmitting a signal receivable only in the range of a predetermined distance to a previously assigned second information processor when a predetermined processing operation is executed in a first information processor or after passage of a predetermined period of time, a decision step of making a determination as to whether a reply signal sent from the second information processor in response to the signal transmitted in the transmitting step has been received, and a processing operation execution step of executing the predetermined processing operation depending upon the result of the determination made in the decision step.

According to the present invention, the predetermined processing operation is performed if the distance between the first and second information processors is equal to or larger than the predetermined distance.

According to the present invention, in the transmitting step, a signal receivable only in the range of a predetermined distance is transmitted to the previously assigned second information processor if a predetermined operation command is issued. In the processing operation execution step, a processing operation corresponding to the predetermined operation command issued in the operation command input step is executed depending upon the result of the determination made in the decision step.

According to the present invention, the operation command is effective if the distance between the first and second information processors is smaller than the predetermined distance.

According to a further aspect of the present invention, there is provided an information processing method comprising a receiving step of receiving a signal transmitted from an external device to a first information processor, a transmitting step of transmitting a signal receivable only in the range of a predetermined distance to a second information processor when a signal is received in the receiving step, a decision step of making a determination as to whether a reply signal sent from the second information processor in response to the signal transmitted in the transmitting step has been received, and an alert step of performing alerting with respect to the reception of the signal in the receiving step depending upon the result of the determination made in the decision step.

According to the present invention, it is possible to know that the signal transmitted from the external device has been received if the distance between the first and second information processors is smaller than the predetermined distance.

According to still a further aspect of the present invention, there is provided a computer-readable recording medium having a program recorded thereon. The program enables a computer to perform a process based on any one of the above-described methods.

According to the present invention, a recording medium is provided on which a program for making a computer perform a process based on one of the above-described methods is recorded, so that the program can be recorded in a machine-readable state. This recording medium enables each of the above-described methods to be practiced by using a computer.

### BRIEF DESCRIPTION OF THE DRAWINGS

In the accompanying drawings:

FIG. 1 is a diagram showing an example of the configuration of an information processing system including information processors according an embodiment of the present invention;

FIG. 2 is a block diagram showing an example of the hardware configuration of an information processor (portable telephone, wristwatch type information processor) according to the embodiment of the present invention;

FIG. 3 is a block diagram showing an example of the configuration of the information processor (portable telephone, wristwatch type information processor) according to the embodiment of the invention with respect to the functions thereof;

FIG. 4 is a block diagram showing another example of the configuration of the information processor (portable telephone, wristwatch type information processor) according to the embodiment of the invention with respect to the functions thereof;

FIG. 5 is a flowchart showing a process performed by the information processors according to the embodiment of the invention;

FIG. 6 is a flowchart showing another process performed by the information processors according to the embodiment of the invention; and

FIG. 7 is a flowchart showing still another process performed by the information processors according to the embodiment of the invention.

### DETAILED DESCRIPTION OF THE PREFERRED EMBODIMENTS

The present invention will be described in detail with reference to the accompanying drawings with respect to an embodiment thereof, represented by an information processor, an information processing method and a computer-readable recording medium on which a program for making a computer perform a process based on the method is recorded.

(Configuration of Information Processing System)

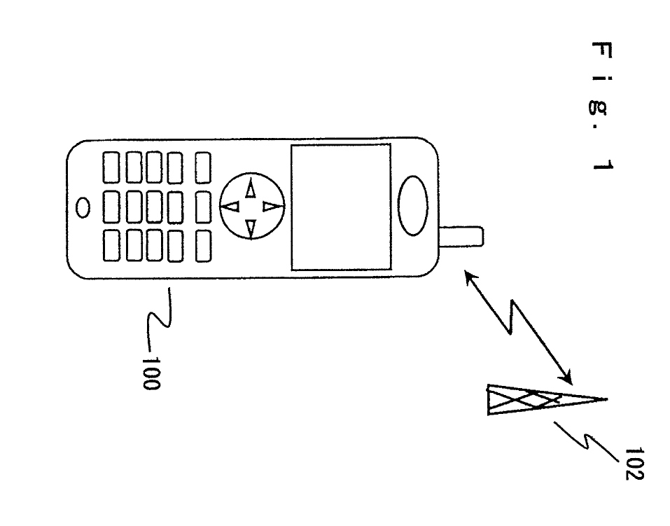

FIG. 1 is a diagram showing an example of the configuration of an information processing system including information processors according the embodiment of the present invention. Referring to FIG. 1, the information processing system is constituted by a first information processor (portable telephone) 100, a second information processor (wristwatch type information processor) 101, and a repeating station (base station) 102.

The first information processor (portable telephone) 100 is an information processor in the form of a portable telephone, a portable unit of the Personal Handy Phone System (PHS), a mobile personal computer, a radio pager, or the like capable of performing unidirectional or bidirectional communication with the repeating station 102. The functions for communication with the repeating station (base station) 102 can be performed based on the conventional techniques and, therefore, will not specially be described in detail.

The second information processor (wristwatch type information processor) 101 itself does not perform communication with the repeating station (base station) 102, but can perform short-distance wireless communication with the first information processor (portable telephone) 100. The second information processor 101 is a wristwatch type information processor in this embodiment. The possessor of the first and second information processors 100 and 101 ordinarily wears the second information processor 101 on a wrist, enabling the first information processor 100 to recognize whether the distance between the possessor (user) and the first information processor 100 is short enough to perform short-distance wireless communication.

The second information processor 101 is not limited to the wristwatch type information processor, and may be of any other type as long as it can always be carried by the possessor (user). For example, it may be of a pendant type such as to be suspended from the possessor's neck, or of such a type as to be attached to a jacket or the like.

A portable telephone is ordinarily carried by the possessor (user). However, the possessor (user) may lose or mislay the portable telephone in a particular place (e.g., possessor's home or an office) or the portable telephone may be stolen. In such a case, it is probable that the distance between the point at which the portable telephone is located and the point at which the possessor (user) is located is longer than the maximum distance over which short-distance wireless communication can be performed.

Also, in a case where a person works by operating a particular type of information processor (e.g., a personal computer) on a desk, the operator may leave from the desk for some purpose, and the distance between the point at which the portable telephone is located and the point at which the possessor (user) may become longer than the maximum distance over which short-distance wireless communication can be performed.

For short-distance wireless communication between the first information processor (portable telephone) 100 and the second information processor (wristwatch type information processor) 101, a short-distance wireless communication, e.g., “Bluetooth” may be used. “Bluetooth” uses a frequency bandwidth of 2.45 GHz, a connection distance coverage of about 10 m, and a transfer rate of about 1 Mbps. Therefore, if a port in accordance with “Bluetooth” is provided, various devices, such as portable telephones, portable personal computers and peripheral devices, can be connected.

(Configuration of Information Processor)

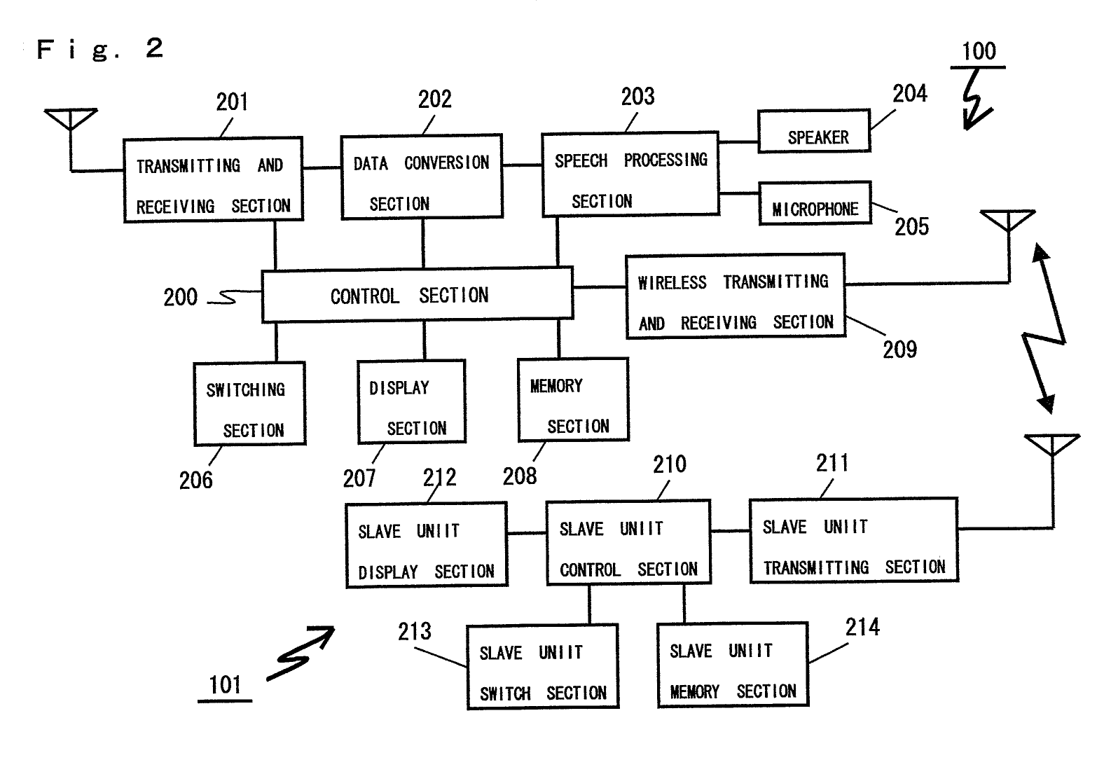

The hardware configuration of the first information processor (portable telephone) 100 and the second information processor (wristwatch type information processor) 101 will next be described with reference to FIG. 2, which is a block diagram showing an example of the hardware configuration of the first and second information processors (portable telephone and wristwatch type information processor) according to this embodiment.

Referring to the block diagram of FIG. 2, the first information processor (portable telephone) 100 is constituted by a control section 200, a transmitting and receiving section 201, a data conversion section 202, a speech processing section 203, a speaker 204, a microphone 205, a switch section 206, a display section 207, a memory section 208, and a wireless transmitting and receiving section 209.

The control section 200 is constituted by, for example, a central processing unit (CPU), and performs overall control of the processor. The transmitting and receiving section 201 is constituted by a communication unit, a modem, etc., and performs communication with the repeating station (base station) 102. The data conversion section 202 converts data received by the transmitting and receiving section 201 into data processible by speech processing in the speech processing section 203 and, conversely, converts data speech-processed by the speech processing section 203 into data transmittable by the transmitting and receiving section 201.

The speech processing section 203 converts data supplied from the data conversion section 202 into speech data which can be output through the speaker 204. Conversely, the speech processing section 203 converts a speech input from the microphone 205 into data to be supplied to the data conversion section 202. The speaker 204 is operated to output speech, and the microphone 205 is operated to input speech.

The switch section 206 is provided to operate the information processor in various ways. For example, the switch section 206 comprises a keyboard or a touch panel. If the information processor is a portable telephone, the switch section 206 comprises a ten-key cluster, a power switch, etc. The display section 207 is a thin film transistor (TFT) liquid crystal display or the like. The display section 207 displays details of an operation, operation results, etc. The switch section 206 can be operated to make a mode change to or from a handshaking mode described below.

The memory section 208 is constituted by various kinds read only memory (ROM), a random access memory (RAM), etc. The memory section 208 can store programs executed by the control section 200 and various kinds of data (including directory data or the like in the case of a portable telephone). The wireless transmitting and receiving section 209 performs communication with the wristwatch type information processor 101.

The second information processor (wristwatch type information processor (slave unit)) 101 is constituted by a salve unit control section 210, a slave unit transmitting and receiving section 211, a slave unit display section 212, a slave unit switch section 213, and a slave unit memory section 214.

The slave unit control section 210 is constituted by, for example, a microprocessor forming a CPU, and performs overall control of the slave unit. The slave unit transmitting and receiving section 211 performs communication with the information processor 100. The slave unit display section 212 is constituted by a display screen in the face of a wristwatch. The slave unit display section 212 displays, as well as time, conditions of communication with the information processor 100, details of an operation, operation results, etc.

The slave unit switch section 213, not shown in detail, is constituted by switch elements provided in a side surface of an upper surface of the body of the wristwatch type information processor. Through the slave unit switch section 213, the slave unit is operated in various ways. The slave unit memory section 214 is constituted by various kinds of ROM, RAM, etc. The salve unit memory section 214 can store a program executed by the slave unit control section 210 and various kinds of data.

(Functional Configuration of Information Processor)

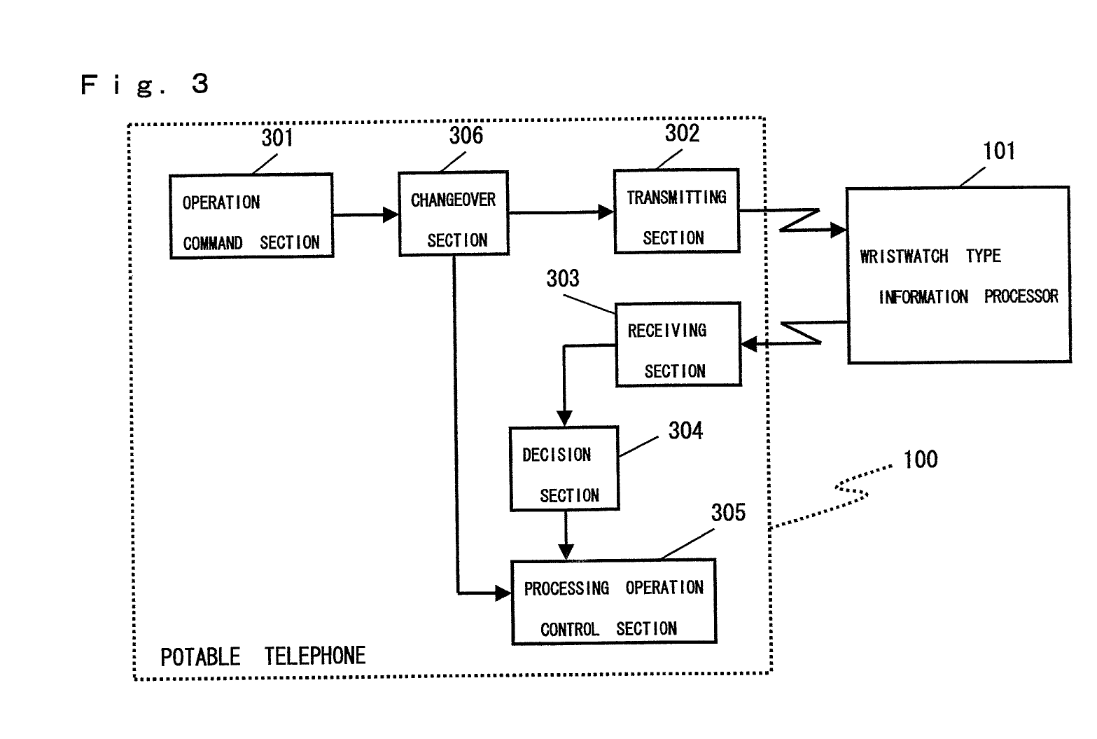

The functional configuration of the first information processor (portable telephone) 100 and the second information processor (wristwatch type information processor) 101 will next be described with reference to FIG. 3, which is a block diagram showing an example of the configuration of the information processors (portable telephone and wristwatch type information processor) according to this embodiment with respect to the functions thereof.

Referring to the block diagram of FIG. 3, the first information processor (portable telephone) 100 has an operation command section 301, a transmitting section 302, a receiving section 303, a decision section 304, a processing operation control section 305, and a changeover section 306. The operation command section 301 can command to perform operations relating to each of the functions of the information processor 100. More specifically, the function of the operation command section 301 is realized by using the switch section 206.

The transmitting section 302 transmits, to the previously assigned second information processor (wristwatch type information processor) 101, a signal which can be received only within the range of a predetermined distance from the first information processor. More specifically, the function of the transmitting section 302 is realized by using the wireless transmitting and receiving section 209. For example, when the operation command section 301 issues a predetermined operation command to the transmitting section 302, the transmitting section 302 starts transmitting. The transmitting section 302 may start transmitting by other means. For example, it may be started by a timer (not shown) mounted on the operation command section 301 to transmit after passage of a predetermined time period from the preceding issue of the operation command.

The receiving section 303 receives a reply signal which is transmitted from the wristwatch type information processor 101 as a reply to the signal transmitted by the transmitting section 302. More specifically, the function of the receiving section 303 is realized by using the wireless transmitting and receiving section 209, as is that of the transmitting section 302. The decision section 304 makes a determination as to whether the reply signal is received by the receiving section 303.

The processing operation control section 305 executes a predetermined processing operation depending upon the result of the determination made by the decision section 304. More specifically, the processing operation control section 305 executes a processing operation corresponding to an operation command issued by the operation command section 301. The changeover section 306 changes the operation of the transmitting section 302 between the mode of transmitting to the wristwatch type information processor 101 and the mode of not transmitting. More specifically, this changeover is executed according to an operation command from the switch section 206, as mentioned above.

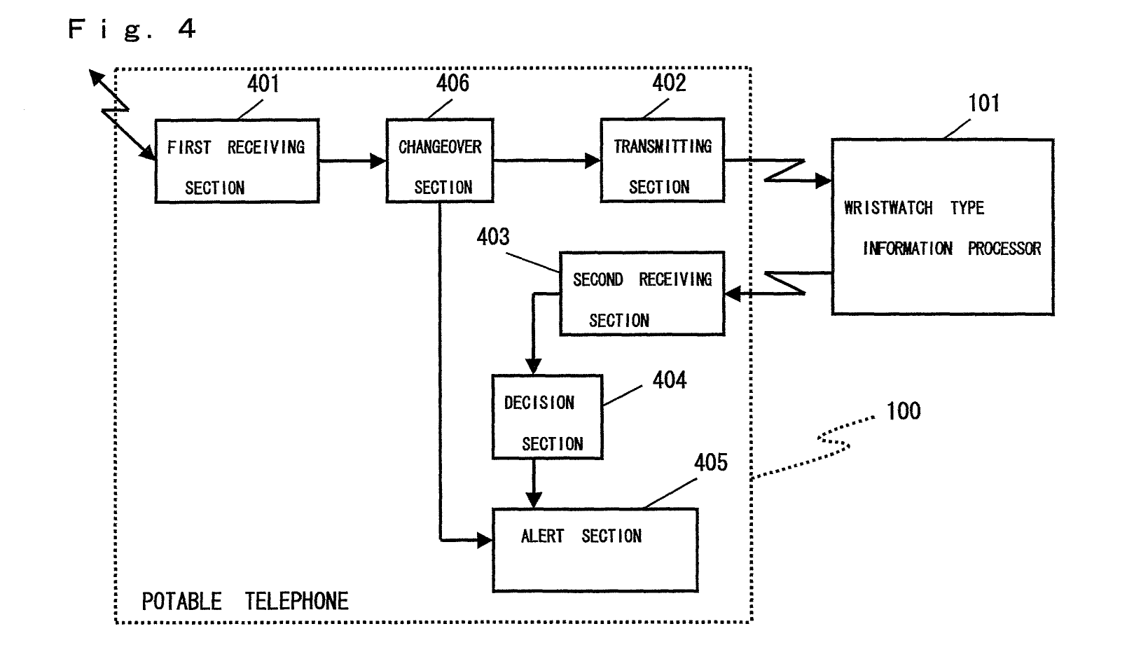

FIG. 4 is a block diagram showing another example of the configuration of the information processors (portable telephone and wristwatch type information processor) according to this embodiment with respect to the functions thereof. Referring to the block diagram of FIG. 4, the first information processor (portable telephone) 100 has a first receiving section 401, a transmitting section 402, a second receiving section 403, a decision section 404, an alert section 405, and a changeover section 406.

The first receiving section 401 receives a signal transmitted from an external device. More specifically, the function of the first receiving section 401 is realized by using the transmitting and receiving section 201 shown in FIG. 2. The transmitted signal from the external device may be, for example, an incoming call signal if the information processor is a portable telephone.

The transmitting section 402 transmits, to the previously assigned wristwatch type information processor 101, a signal which can be received only within the range of a predetermined distance from the first information processor. The second receiving section 403 receives a reply signal which is transmitted from the wristwatch type information processor as a reply to the signal transmitted by the transmitting section 402. More specifically, the functions of the transmitting section 402 and the second receiving section 403 are realized by using the wireless transmitting and receiving section 209.

The decision section 404 makes a determination as to whether the reply signal is received by the receiving section 303, as does the decision section 304 shown in FIG. 3. The alert section 405 corresponds to one possible form of the processing operation control section 305 shown in FIG. 3. When the first receiving section 401 receives a signal, the alert section 405 informs the possessor (user) of the reception of the signal by the first receiving section 401 depending upon the result of the determination made by the decision section 404. A method for this signal reception information is, for example, a method of displaying data in the form of characters, an image or the like through the display section 207 shown in FIG. 2, or a method of outputting a predetermined signal, sound, speech or the like through the speaker 204.

The changeover section 406 changes the operation of the transmitting section 402 between the mode of transmitting to the wristwatch type information processor 101 and the mode of not transmitting, as does the changeover section 306. More specifically, this changeover is executed according to an operation command from the switch section 206, as mentioned above.

(Process Performed by Information Processors)

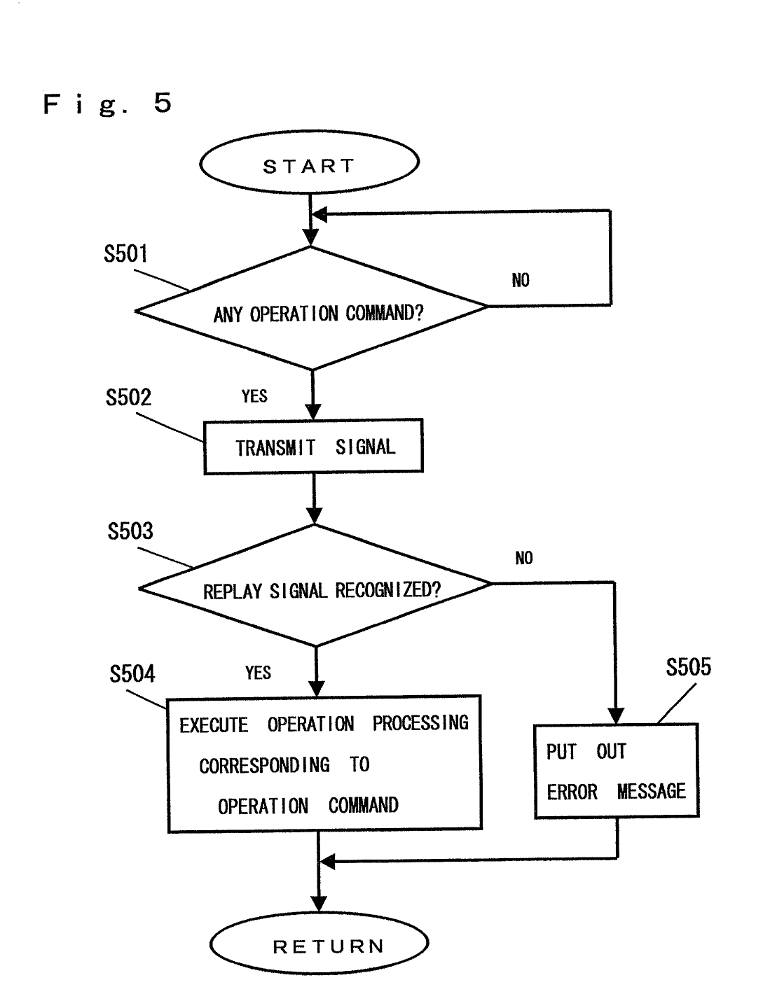

FIG. 5 is a flowchart showing an example of a process performed by the information processors according to this embodiment. Referring to FIG. 5, a determination is first made as to whether an operation command has been given (step S501). An operation command is awaited and, when an operation command is given (if “Yes” in step S501), a predetermined signal is transmitted to the wristwatch type information processor 101 (step S502).

When the wristwatch type information processor 101 receives the signal transmitted in step S502, it sends back, in a predetermined time, a reply signal indicating that it is within the communicatable range. A determination is made as to whether the reply signal has been recognized (received) (step S503).

If it is determined in step S503 that the reply signal has been recognized (if “Yes” in step S503), operation processing corresponding to the operation command given in step S501 is executed (step S504). On the other hand, if it is determined in step S503 that no reply signal has been recognized (if “No” in step S503), it is then determined that the wristwatch type information processor 101 is not within the communicatable range, and an error message is put out to indicate that the operation command issued in step S501 is ineffective (step S505).

One of a setting enabling error messaging in step S505 and a setting not enabling error messaging in step S505 is selected as desired. If the setting for no error messaging has been selected, and if no reply signal is recognized (if “No” in step S503), the processing corresponding to the operation command is not executed and the first information processor 100 itself is set in such a state as to be irresponsive to operation commands, e.g., commands input by operating the keys.

An operation for turning on the power, a dial key inputting, an operation for reading the memory, etc., are thereby inhibited.

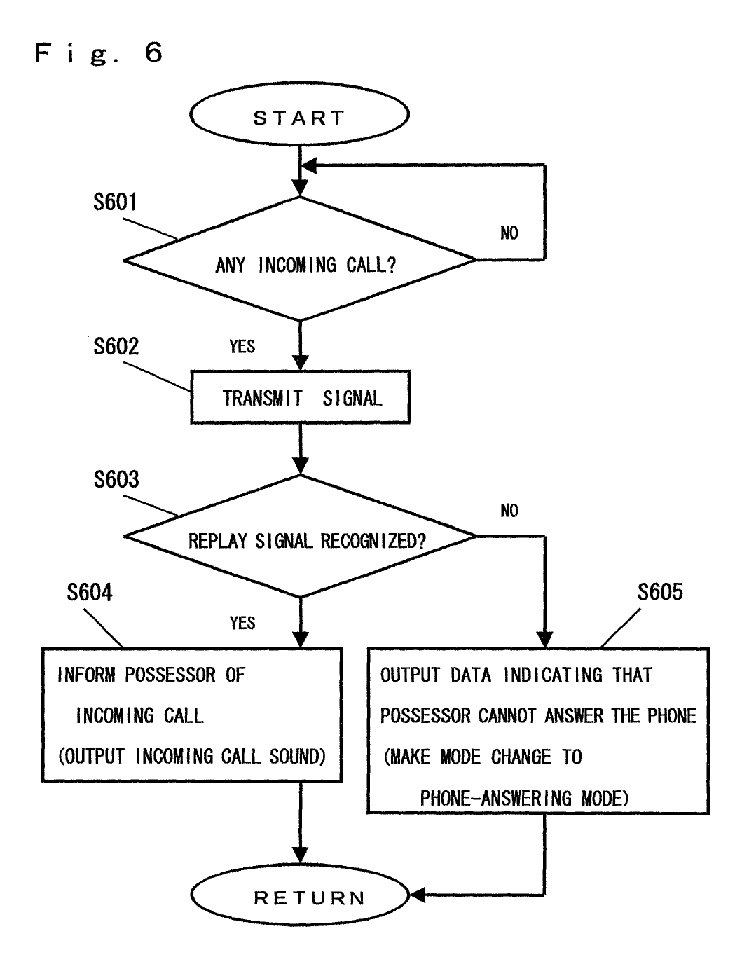

FIG. 6 is a flowchart showing another process performed by the information processors according to this embodiment. Referring to the flowchart of FIG. 6, a determination is first made as to whether an incoming call has been received by the portable telephone 100 (step S601). Arrival of an incoming call is awaited and, when an incoming call is received (if “Yes” in step S601), a predetermined signal is transmitted to the wristwatch type information processor 101 (step S602).

When the wristwatch type information processor 101 receives the signal transmitted in step S602, it immediately sends back a reply signal indicating that it is within the communicatable range. In the portable telephone 100, a determination is made as to whether the reply signal has been recognized (received) (step S603).

If it is determined in step S603 that the reply signal has been recognized (if “Yes” in step S603), alert for warning that the incoming call has been received is performed (step S604). More specifically, an incoming call sound may be output, or the portable telephone 100 itself may vibrate to inform the possessor (user) of the incoming call.

If it is determined in step S603 that no reply signal has been recognized (if “No” in step S603), it is then determined that the wristwatch type information processor 101 is not within the communicatable range, that is, the possessor (user) is away from the portable telephone 100 and in a state of being unable to answer the phone, and data (message) indicating that the possessor (user) cannot answer the phone is output to the other end of the line (step S605).

Since it is apparent that the possessor (user) cannot answer the phone in such a situation, the portable telephone 100 may be set a phone-answering mode while outputting or without outputting the above-mentioned message.

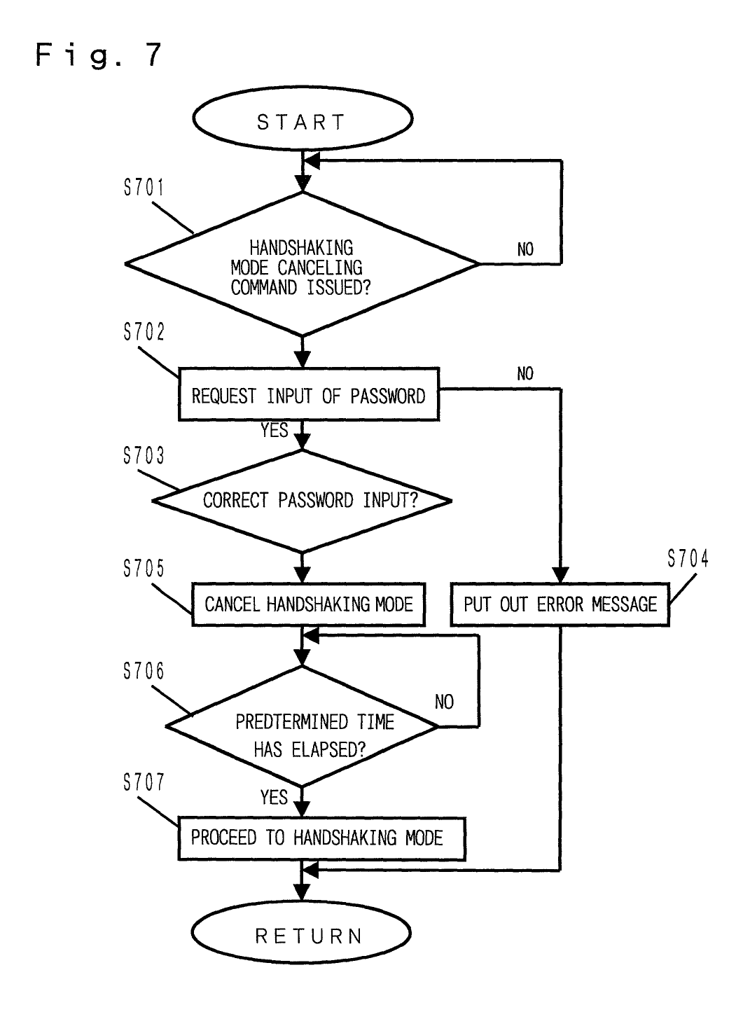

FIG. 7 is a flowchart showing still another process performed by the information processors according to this embodiment. Referring to the flowchart of FIG. 7, a determination is first made (step S701) as to whether a command has been given to cancel a handshaking mode, i.e., a mode for enabling the portable telephone 100 and the wristwatch type information processor 101 to confirm a connection by short-distance wireless communication.

If it is determined in step S701 that a command to cancel the handshaking mode has been given (if “Yes” in step S701), an instructing message for requesting the input of a password is displayed (step S702).

A determination is then made (step S703) as to whether a correct password corresponding to a password previously registered has been input according to the password input instruction in step S702. If it is determined that the correct password has not been input (if “No” in step S703), an error message is put out (step S704) and the process ends (returns).

If it is determined in step S703 that the correct password has been input (if “Yes” in step S703), the abovementioned handshaking mode is canceled (step S705). The portable telephone 100 then performs a predetermined processing operation (or incoming call alert) with respect to an operation command (or an incoming call) without transmitting the above-mentioned predetermined signal to the wristwatch type information processor 101 and without making a determination as to whether a reply signal has been received from the wristwatch type information processor 101.

When the handshaking mode is canceled, the timer is activated. A determination is made as to whether a predetermined period of time has passed after the time when the handshaking mode was canceled (step S706). Elapse of the predetermined time period is awaited and, at the end of the predetermined time period (if “Yes” in step S706), the process proceeds to the state before step S701, i.e., the handshaking mode, and a series of processes are ended (returns).

In this manner, after the handshaking mode has been canceled, the portable telephone 100 can be again set in the handshaking mode without an additional operation for change into the handshaking mode.

In the above-described embodiment, the transmitting section 302 transmits, to the previously assigned wristwatch type information processor 101, a signal receivable only in the range of a predetermined distance; the receiving section 303 receives a reply signal sent from the wristwatch type information processor 101 in response to the transmitted signal; the decision section 304 makes a determination as to whether the reply signal has been received; and the processing operation control section 305 executes a predetermined processing operation depending upon the result of the determination. If the distance to the wristwatch type information processor 101 is equal to or larger than the predetermined distance, the predetermined processing operation is performed.

Thus, a determination is made as to whether the possessor (user) of the information processor 100 is carrying the information processor 100 (or located in the vicinity of the information processor 100), and a suitable processing operation can be performed according to the possessor's (user's) carrying or non-carrying condition.

Also, in the above-described embodiment, in a case where a command to perform a predetermined operation is further issued from the operation command section 301, the transmitting section 302 transmits, to the previously assigned wristwatch type information processor 101, a signal receivable only in the range of a predetermined distance; the receiving section 303 receives a reply signal sent from the wristwatch type information processor 101 in response to the transmitted signal; the decision section 304 makes a determination as to whether the reply signal has been received; and the processing operation control section 305 executes, depending upon the result of the determination, a processing operation corresponding to the operation command issued by the operation command means. If the distance to the wristwatch type information processor 101 is smaller than the predetermined distance, the operation command can be made effective.

Thus, a determination is made as to whether the possessor (user) of the information processor 100 is carrying the information processor 100 (or located in the vicinity of the information processor 100), and a suitable processing operation can be performed according to the possessor's (user's) carrying or non-carrying condition. In particular, when the information processor 100 is not carried by the possessor (user), it can be set so that an unauthorized person cannot operate it without possessor's (user's) permission.

Also, in the above-described embodiment, the first receiving section 401 receives a signal transmitted from an external device; the transmitting section 402 transmits, to the previously assigned wristwatch type information processor 101, a signal receivable only within the range of a predetermined distance when the signal from the external device is received; the second receiving section 403 receives a reply signal transmitted from the wristwatch type information processor 101 in response to the transmitted signal; the decision section 404 makes a determination as to whether the reply signal has been received; the alert section 405 informs the possessor (user) of the reception of the signal from the external device depending upon the result of the determination. If the distance to the wristwatch type information processor 101 is smaller than the predetermined distance, the possessor (user) can be informed of the reception of the signal transmitted from the external device.

Thus, a determination is made as to whether the possessor (user) of the information processor 100 is carrying the information processor 100 (or located in the vicinity of the information processor 100), and a suitable processing operation can be performed according to the possessor's (user's) carrying or non-carrying condition. In particular, when the information processor 100 is not carried by the possessor (user), it is possible to prevent the information processor 100 from annoying people in a place where the information processor exists by alerting when a signal is received. It is also possible to reduce power consumed for signal reception alert when the information processor 100 is not carried by the possessor (user).

Also, in the above-described embodiment, the changeover section 306 or 406 changes the operation of the information processor 100 between the mode of transmitting to the wristwatch type information processor 101 and the mode of not transmitting. Therefore, even if the distance to the wristwatch type information processor 101 is equal to or larger than the predetermined distance, it is possible to inhibit the predetermined operation, to make an operation command effective, and to perform alerting when a signal transmitted from an external device is received.

Thus, a determination is made as to whether the possessor (user) of the information processor 100 is carrying the information processor 100 (or located in the vicinity of the information processor 100), and a suitable processing operation can be performed according to the possessor's (user's) carrying or non-carrying condition. In particular, it is possible to make the information processor 100 usable even when the information processor 100 is not carried by the possessor (user).

In the above-described embodiment, the other information processor is a wristwatch type information processor 101 wearable on a wrist. Therefore, it can always be worn by the possessor (user) to enable the possessor (user) to readily know whether the distance to the information processor 100 is larger than the predetermined distance.

Thus, a determination is made as to whether the possessor (user) of the information processor 100 is carrying the information processor 100 (or located in the vicinity of the information processor 100), and a suitable processing operation can be performed according to the possessor's (user's) carrying or non-carrying condition. In particular, it is possible to easily control the information processor 100 by performing only a routine operation, i.e., wearing the wristwatch.

The information processing method described with respect to the embodiment of the present invention can be practiced by executing a prepared program in a computer such as a personal computer or a workstation. This program is recorded on a computer-readable recording medium, such as a hard disk, a floppy disk, a compact disk-read only memory (CD-ROM), a magneto-optical disc (MO), or a digital versatile disc (DVD), and is executed by being read out from the recording medium by the computer. Also, this program can be distributed through the recording medium or through a transmission medium such as the Internet or any other network.

According to the present invention, as described above, an information processor can be obtained which transmits, to another information processor previously assigned, a signal receivable only in the range of a predetermined distance, receives a reply signal sent from the other information processor in response to the transmitted signal, makes a determination as to whether the reply signal has been received, and executes a predetermined processing operation depending upon the result of the determination. This information processor performs the predetermined processing operation if the distance to the other information processor is equal to or larger than the predetermined distance. In this manner, the information processor can make a determination as to whether the possessor (user) of the information processor is carrying the information processor (or located in the vicinity of the information processor), and can perform a suitable processing operation according to the possessor's (user's) carrying or non-carrying condition.

According to the present invention, another information processor can also be obtained which has operation command means for commanding to perform operations, and which transmits, to another information processor previously assigned, a signal receivable only in the range of a predetermined distance when a predetermined operation command is issued from the operation command means, receives a reply signal sent from the other information processor in response to the transmitted signal, makes a determination as to whether the reply signal has been received, and executes a processing operation corresponding to the operation command issued by the operation command means depending upon the result of the determination. This information processor can make the operation command effective if the distance to the other information processor is smaller than the predetermined distance. In this manner, the information processor can make a determination as to whether the possessor (user) of the information processor is carrying the information processor (or located in the vicinity of the information processor), and can perform a suitable processing operation according to the possessor's (user's) carrying or non-carrying condition.

According to the present invention, still another information processor can be obtained which receives a signal transmitted from an external device, transmits, to another information processor previously assigned, a signal receivable only in the range of a predetermined distance when the signal from the external device is received, receives a reply signal sent from the other information processor in response to the transmitted signal, makes a determination as to whether the reply signal has been received, and performs, depending upon the result of the determination, alerting for informing the possessor (user) that the signal transmitted from the external device has been received. This information processor enables the possessor (user) to know that the signal transmitted from the external device has been received if the distance to the other information processor is smaller than the predetermined distance. In this manner, the information processor can make a determination as to whether the possessor (user) of the information processor is carrying the information processor (or located in the vicinity of the information processor), and can perform a suitable processing operation according to the possessor's (user's) carrying or non-carrying condition.

According to the present invention, the information processor also has means for changing the operation of the information processor between the mode of transmitting to the other information processor and the mode of not transmitting. Therefore, even if the distance to the other information processor is equal to or larger than the predetermined distance, it is possible to inhibit the predetermined operation, to make an operation command effective, and to perform alerting when a signal transmitted from an external device is received. In this manner, the information processor can make a determination as to whether the possessor (user) of the information processor is carrying the information processor (or located in the vicinity of the information processor), and can perform a suitable processing operation according to the possessor's (user's) carrying or non-carrying condition.

According to the present invention, the other information processor is a wristwatch type information processor wearable on a wrist. Therefore, it can always be worn by the possessor (user) to enable the possessor (user) to readily know whether the distance to the information processor is larger than the predetermined distance. Therefore, the information processor can make a determination as to whether the possessor (user) of the information processor is carrying the information processor (or located in the vicinity of the information processor), and can perform a suitable processing operation according to the possessor's (user's) carrying or non-carrying condition.

According to the present invention, an information processing method can be obtained in which, when a predetermined processing operation is executed or after passage of a predetermined period of time, a signal receivable only in the range of a predetermined distance is transmitted to the other information processor previously assigned; a determination is made as to whether a reply signal sent from the other information processor in response to the transmitted signal has been received; and the predetermined processing operation is executed depending upon the result of the determination. The predetermined processing operation is executed if the distance to the other information processor is equal to or larger than the predetermined distance.

Thus, a determination is made as to whether the possessor (user) of the information processor is carrying the information processor (or located in the vicinity of the information processor), and a suitable processing operation can be performed according to the possessor's (user's) carrying or non-carrying condition.

According to the present invention, another information processing method can be obtained in which, if a command to perform a predetermined operation is issued, a signal receivable only in the range of a predetermined distance is transmitted to the other information processor previously assigned; a determination is made as to whether a reply signal sent from the other information processor in response to the transmitted signal has been received; a processing operation corresponding to the issued operation command is executed depending upon the result of the determination. If the distance to the other information processor is smaller than the predetermined distance, the operation command is effective. Thus, a determination is made as to whether the possessor (user) of the information processor is carrying the information processor (or located in the vicinity of the information processor), and a suitable processing operation can be performed according to the possessor's (user's) carrying or non-carrying condition.

According to the present invention, still another information processing method can be obtained in which a signal transmitted from an external device is received; when this signal is received, a signal receivable only in the range of a predetermined distance is transmitted to the other information processor previously assigned; a determination is made as to whether a reply signal sent from the other information processor in response to the transmitted signal has been received; and alerting is performed depending upon the result of the determination to inform the possessor (user) of the reception of the signal from the external device. If the distance to the other information processor is smaller than the predetermined distance, the possessor (user) can be informed of the reception of the signal transmitted from the external device. Thus, a determination is made as to whether the possessor (user) of the information processor is carrying the information processor (or located in the vicinity of the information processor), and a suitable processing operation can be performed according to the possessor's (user's) carrying or non-carrying condition.

According to the present invention, a recording medium can be provided on which a program for making a computer perform a process based on one of the above-described information processing methods is recorded. The program can be recorded in a machine-readable state. This recording medium enables each of the above-described methods to be practiced by using a computer.

What is claimed is:

1. An information processor comprising:
a transmitter to transmit a signal receivable only in the range of a predetermined distance to another information processor previously assigned;
a receiver to receive a reply signal sent from said another information processor in response to the signal transmitted by said transmitter;
a decision circuit to make a determination as to whether the reply signal has been received by said receiver; and
a processing operation controller to execute a predetermined processing operation depending upon the result of the determination made by said decision circuit.

2. An information processor according to claim 1, further comprising operation command circuit to issue commands to perform operations,
wherein said transmitter transmits the signal receivable only in the range of the predetermined distance to said another previously assigned information processor if a predetermined operation command is issued from said operation command circuit, and
wherein said processing operation controller executes a processing operation corresponding to the operation command issued by said operation command circuit depending upon the result of the determination made by said decision circuit.

3. An information processor comprising:
a first receiver to receive a signal transmitted from an external device;
a transmitter to transmit a signal receivable only in the range of a predetermined distance to another previously assigned information processor when a signal is received by said first receiver;
a second receiver to receive a reply signal sent from said another information processor in response to the signal transmitted by said transmitter;
a decision circuit to make a determination as to whether the reply signal has been received by said second receiver; and
an alert circuit to perform alerting with respect to the reception of the signal by said first receiver depending upon the result of the determination made by said decision circuit.

4. An information processor according to claim 1, further comprising changeover circuit to change said transmitter between the mode of transmitting to said another information processor and the mode of not transmitting.

5. An information processor according to claim 3, further comprising changeover circuit to change said transmitter between the mode of transmitting to said another information processor and the mode of not transmitting.

6. An information processor according to claim 1, wherein said another information processor is an information processor wearable on a wrist.

7. An information processor according to claim 3, wherein said another information processor is an information processor wearable on a wrist.

8. An information processing method comprising:
a transmitting step of transmitting a signal receivable only in the range of a predetermined distance to a previously assigned second information processor when a predetermined processing operation is executed in a first information processor or after passage of a predetermined period of time;
a decision step of making a determination as to whether a reply signal sent from the second information processor in response to the signal transmitted in said transmitting step has been received; and
a processing operation execution step of executing the predetermined processing operation depending upon the result of the determination made in said decision step.

9. An information processing method according to claim 8, wherein, in said transmitting step, a signal receivable only in the range of a predetermined distance is transmitted to the previously assigned second information processor if a predetermined operation command is issued, and
wherein, in said processing operation execution step, a processing operation corresponding to the predetermined operation command issued in said operation command input step is executed depending upon the result of the determination made in said decision step.

10. An information processing method comprising:
a receiving step of receiving a signal transmitted from an external device to a first information processor;
a transmitting step of transmitting a signal receivable only in the range of a predetermined distance to a previously assigned second information processor when a signal is received in said receiving step;
a decision step of making a determination as to whether a reply signal sent from the second information processor in response to the signal transmitted in said transmitting step has been received; and
an alert step of performing alerting with respect to the reception of the signal in said receiving step depending upon the result of the determination made in said decision step.

11. A computer readable recording medium comprising a program recorded thereon, said program to make a computer perform a process based on the method according to claim 8.

12. A computer readable recording medium comprising a program recorded thereon, said program to make a computer perform a process based on the method according to claim 10.
